(19) United States
(12) Patent Application Publication
(10) Pub. No.: US 2026/0098961 A1
(43) Pub. Date: Apr. 9, 2026

(54) ROBUST TIME-SERIES INSAR DEFORMATION MONITORING BY INTEGRATING VARIATIONAL MODE DECOMPOSITION AND GATED RECURRENT UNITS

(71) Applicant: The Chinese University of Hong Kong, Hong Kong (CN)

(72) Inventors: Peifeng MA, Hong Kong (CN); Zeyu JIAO, Hong Kong (CN); Zherong WU, Hong Kong (CN); Guangen YE, Hong Kong (CN)

(21) Appl. No.: 19/352,677

(22) Filed: Oct. 8, 2025

Related U.S. Application Data
(60) Provisional application No. 63/704,624, filed on Oct. 8, 2024.

(51) Int. Cl. G01S 13/90; G06N 3/0442

(52) U.S. Cl. CPC G01S 13/9094; G01S 13/9017; G01S 13/9023; G06N 3/0442

(57) ABSTRACT

A surface deformation monitoring method and systems based on time-series InSAR (TS-InSAR) are provided. The method includes acquiring Synthetic Aperture Radar (SAR) data; performing differential interferometry; performing a robust two-tier multi-temporal InSAR method for detection of Persistent Scatterer (PS) and Distributed Scatterer (DS) candidates to acquire time series data for surface deformation monitoring; performing a variational mode decomposition (VMD) method to decompose TS-InSAR data into a plurality of components; reconstructing time series data; performing a gated recurrent unit (GRU) method; extracting trend of surface deformation; and performing continuous large-scale deformation monitoring. The InSAR-based deformation monitoring method integrates VMD and GRU, offering significant improvements in robustness and accuracy over the existing methods.

### CROSS-REFERENCE TO RELATED APPLICATION

The present application claims the benefit of U.S. Provisional Application Ser. No. 63/704,624, filed Oct. 8, 2024, which is hereby incorporated by reference herein in its entirety, including any figures, tables, or drawings.

### BACKGROUND OF THE INVENTION

Interferometric Synthetic Aperture Radar (InSAR) is a powerful geodetic technique that enables the remote monitoring of Earth's surface with high resolution and broad spatial coverage, under all conditions. It has proven invaluable in various geophysical applications, including the monitoring of earthquake, volcanic activity, and tectonic movements [1], [2], [3], [4], [5]. Time-series InSAR (TS-InSAR), an advanced evolution of the InSAR technique, harnesses time-series of SAR images or interferograms to precisely measure geodetic and geophysical parameters, such as ground displacements [6], [7], [8].

A key challenge in InSAR is the mitigation of atmospheric delays; TS-InSAR addresses this through temporal filtering and least-squares methods, thereby enhancing the accuracy of deformation estimates [9], [10], [11]. The ability of TS-InSAR to monitor surface deformation is thus of great importance, providing high-precision, wide coverage, and consistent data essential for tracking Earth's movements.

When employing TS-InSAR for surface deformation monitoring, atmospheric delays in interferograms, resulting from changes in atmospheric refractivity during two SAR acquisitions, pose a significant source of error in TS-InSAR measurements [12], [13]. These delays comprise three main components. The first is a short-scale component (a few kilometers), likely introduced by turbulent or coherent dynamics in the troposphere [14]. The second is a longer-scale component (tens of kilometers), which potentially stems from lateral variations in pressure, temperature, or humidity. Lastly, there is a topography-correlated component, caused by changes in pressure, temperature, or relative humidity as a function of height [15].

These atmospheric delays in TS-InSAR not only include systematic biases but also contain stochastic components, making these delays among the most challenging factors to model accurately [16]. As a result, significant research efforts are focused on exploring the spatiotemporal characteristics of atmospheric delays to enhance the accuracy and reliability of TS-InSAR for surface deformation monitoring.

The tropospheric delay, which can be categorized into stratified delay and turbulent mixing delay, results from the refraction of radar signals as they pass through the troposphere [14]. The stratified delay is dependent on pressure and temperature and correlates with topography, while the turbulent mixing delay primarily depends on water vapor variations, which can be particularly severe in coastal and mountainous regions [17].

In the context of TS-InSAR, where the data comprise numerous images without extensive temporal gaps, the tropospheric delay is generally assumed to be uncorrelated over time, as each image mainly captures the turbulent mixing delays [18], [19]. In urban areas with low relief, the turbulent mixing delay often dominates the atmospheric delay, leading to the assumption that atmospheric noise in the InSAR deformation time series is stochastic. Common approaches to estimate and mitigate this atmospheric noise in the deformation time series involve low-pass temporal filtering techniques, such as Gaussian and triangular filtering [20], [21].

However, the effectiveness of these methods greatly depends on parameter settings, including the choice of weighting strategies and the length of the filtering window. An inadequate filtering process could either leave residual noise in the deformation or obscure minor changes in the data.

As deep learning has made remarkable progress in fields such as computer vision [22], [23], speech recognition [24], and natural language processing [25], applying deep learning to TS-InSAR analysis shows considerable promise in alleviating atmospheric delay and improving monitoring accuracy. Recurrent neural network (RNN) and its variants, such as long short-term memory (LSTM) [26], and gated recurrent unit (GRU) [27], are specialized for discrete sequence analysis tasks such as time series denoising, forecasting or change detection in the realm of remote sensing [28], [29].

Given the non-stationary nature of InSAR data, previous studies usually divide its time series into three signals: seasonal, non-seasonal and noise [30], [31].

This approach effectively improves the possibility of using deep learning to model different components in InSAR time series. However, two significant challenges remain in applying deep learning-based methods to continuous and large-scale surface deformation:
1. Annual seasonal variation: Existing deep learning methods assume seasonal components as static periodic functions irrespective of interannual variances in seasonal intensities, risking progressively cumulative monitoring errors [32].
2. Abnormal outliers: Abnormal outliers in InSAR data, often stemming from atmospheric anomalies or instrumental errors, can significantly distort analysis, posing challenges to both traditional and deep learning models by potentially causing overfitting and misleading interpretations of surface deformation trends [33].

For continues large-scale monitoring, ground deformation is related to geological conditions and is almost monotonous. Meanwhile, seasonal variations in ground deformation are mainly influenced by weather and hydrological conditions [34], [35]. Noise is present in every SAR image acquisition and is a component that changes at high frequency. This implies that different frequencies associated with the three components of trend, season, and noise, can be leveraged as prior information to improve the robustness of TS-InSAR analysis.

### BRIEF SUMMARY OF THE INVENTION

There continues to be a need in the art for improved designs and techniques for a robust time-series inSAR deformation monitoring method and systems.

According to an embodiment of the subject invention, a surface deformation monitoring method based on time-series InSAR (TS-InSAR) is provided. The method comprises acquiring Synthetic Aperture Radar (SAR) data; performing differential interferometry; performing a robust two-tier multi-temporal InSAR method for detection of Persistent Scatterer (PS) and Distributed Scatterer (DS) candidates to acquire time series data for surface deformation monitoring; performing a variational mode decomposition (VMD) method to decompose TS-InSAR data into a plurality of components; reconstructing time series data; performing a gated recurrent unit (GRU) method; extracting trend of surface deformation; and performing continuous large-scale deformation monitoring. The performing a robust two-tier multi-temporal InSAR method comprises determining whether condition 1 is satisfied. If condition 1 is satisfied, more stable Persistent Scatterer (PS) candidates are identified to serve as reference. Moreover, a first-tier network is constructed, whether PSt1 is greater than a first preset value is determined. If PSt1 is smaller than or equal to a first preset value, then a second-tier network is constructed. Furthermore, whether PSt2 is greater than a second preset value and DSt2 is greater than a third preset value are determined. If PSt2 is greater than the second preset value and DSt2 is greater than the third preset value, then a robust estimation method and InSAR deformation of time-series are performed. If PSt1 is greater than the first preset value, then performing the robust estimation method and performing the InSAR deformation of time-series. In addition, if condition 1 is not satisfied, a coherence-weighted phase-linking (CWPL) method is performed for phase optimization and more PS candidates and DS candidates are identified. Moreover, the constructing a second-tier network is performed and whether PSt2 is greater than the second preset value and DSt2 is greater than the third preset value is determined. If PSt2 is greater than the second preset value and DSt2 is greater than the third preset value, the robust estimation method and the InSAR deformation of time-series are performed. In addition, the VMD method receives physics-based synthetic data as an input and the plurality of components include a trend component, a season component, and a noise component. Further, the reconstructing time series comprises reconstructing time series data by removing the seasonal component. The GRU method receives synthetic data ground truth as an input and the performing a GRU method comprises refining reconstructed TS-InSAR data by the GRU method to eliminate noise and outliers.

In another embodiment, a non-transitory computer readable medium having stored therein program instructions executable by a computing system to cause the computing system to perform a surface deformation monitoring method based on time-series InSAR (TS-InSAR) is provided. The method comprises acquiring Synthetic Aperture Radar (SAR) data; performing differential interferometry; performing a robust two-tier multi-temporal InSAR method for detection of Persistent Scatterer (PS) and Distributed Scatterer (DS) candidates to acquire time series data for surface deformation monitoring; performing a variational mode decomposition (VMD) method to decompose TS-InSAR data into a plurality of components; reconstructing time series data; performing a gated recurrent unit (GRU) method; extracting trend of surface deformation; and performing continuous large-scale deformation monitoring. The performing a robust two-tier multi-temporal InSAR method comprises determining whether condition 1 is satisfied. If condition 1 is satisfied, more stable Persistent Scatterer (PS) candidates are identified to serve as reference. Moreover, a first-tier network is constructed, whether PSt1 is greater than a first preset value is determined. If PSt1 is smaller than or equal to a first preset value, then a second-tier network is constructed. Furthermore, whether PSt2 is greater than a second preset value and DSt2 is greater than a third preset value are determined. If PSt2 is greater than the second preset value and DSt2 is greater than the third preset value, then a robust estimation method and InSAR deformation of time-series are performed. If PSt1 is greater than the first preset value, then performing the robust estimation method and performing the InSAR deformation of time-series. In addition, if condition 1 is not satisfied, a coherence-weighted phase-linking (CWPL) method is performed for phase optimization and more PS candidates and DS candidates are identified. Moreover, the constructing a second-tier network is performed and whether PSt2 is greater than the second preset value and DSt2 is greater than the third preset value is determined. If PSt2 is greater than the second preset value and DSt2 is greater than the third preset value, the robust estimation method and the InSAR deformation of time-series are performed. In addition, the VMD method receives physics-based synthetic data as an input and the plurality of components include a trend component, a season component, and a noise component. Further, the reconstructing time series comprises reconstructing time series data by removing the seasonal component. The GRU method receives synthetic data ground truth as an input and the performing a GRU method comprises refining reconstructed TS-InSAR data by the GRU method to eliminate noise and outliers.

### BRIEF DESCRIPTION OF THE DRAWINGS

FIG. 1 shows workflow of the robust surface deformation monitoring method, according to an embodiment of the subject invention.

FIG. 2 is a schematic representation of an architecture of the variational mode decomposition (VMD)-GRU model, according to an embodiment of the subject invention.

FIG. 3 is an image showing locations of the real-world study area, wherein the red box is the SAR coverage area, and the blue triangle indicates the positions of the GNSS stations, according to an embodiment of the subject invention.

FIGS. 4A-4E show examples of the VMD-GRU on synthetic data, wherein FIG. 4A shows the original synthetic data, where the red is the synthetic time series data, and the ground truth trend and seasonal signals are represented in blue and green, respectively, wherein FIGS. 4B, 4C and 4D are three components separated by VMD, corresponding to trend, season and noise respectively, the green line in FIG. 4C represents the ground truth of the seasonal component, consistent with the green in FIG. 4A, the black in FIG. 4E represents the reconstructed time series after removing the seasonal component separated by VMD, and the blue is the ground truth trend component, which is consistent with that in FIG. 4A, the trend component separated after VMD-GRU is indicated in orange, according to an embodiment of the subject invention.

FIGS. 5A-5C show spatial distribution of cumulative deformation in different periods, according to an embodiment of the subject invention.

FIG. 6 shows results of different methods on the time series data obtained from Lantau Island, wherein the red line is the original InSAR time series, the wine-red line is the surface deformation trend estimated by the traditional GRU method, the black line is the VMD-GRU estimated surface deformation trend, and the green line is the GNSS measurement, the annual average deformation velocity obtained by GNSS, the traditional GRU method, and the VMD-GRU are 1.081 mm/yr, 3.925 mm/yr, and 1.009 mm/yr, respectively, according to an embodiment of the subject invention.

FIGS. 7A-7B shows decomposition results of VMD for the above time series data, wherein FIG. 7A shows the original time series, the seasonal components decomposed by VMD, and the reconstructed time series from top to bottom, and FIG. 7B shows the spectrum diagram during the decomposition process of each component, according to an embodiment of the subject invention.

FIGS. 8A-8C show test results of different methods on GBA data, wherein each row corresponds to the cumulative deformation spatial distribution of the surface in different periods, and each column corresponds to the original time series data, results of the Gaussian filtering, results of the traditional GRU method, and results of the VMD-GRU, according to an embodiment of the subject invention.

FIG. 9 shows test results of different methods in the subsidence area of GBA, according to an embodiment of the subject invention.

FIG. 10 shows exemplary results on the synthetic dataset with annual seasonal variation, wherein the traditional GRU method separates the fixed-amplitude seasonal and trend components shown as blue and purple lines, respectively, seasonal and trend components separated based on VMD-GRU are shown in green and orange, respectively, according to an embodiment of the subject invention.

FIGS. 11A-11C show performance of VMD-GRU and existing methods on ALOS data, according to an embodiment of the subject invention.

FIG. 12 shows spectrum diagram of the ALOS time series data decomposed by VMD, according to an embodiment of the subject invention.

### DETAILED DISCLOSURE OF THE INVENTION

The embodiments of subject invention pertain to a surface deformation monitoring method and systems based on time-series InSAR (TS-InSAR).

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The method of the subject invention offers a novel perspective on TS-InSAR data by examining it through the lens of the frequency domain. The crucial aspect of pre-existing knowledge pertaining to the frequency of each data component has often been disregarded when identifying their causes. As previously stated, surface deformation trends are predominantly influenced by geological and hydrological conditions, resulting in largely monotonic variations over continuous monitoring. This implies that the trend component corresponds to a low-frequency signal. The seasonal component, cycling annually, aligns with a specific frequency signal. While the noise component, inherent in every acquisition, corresponds to a high-frequency signal in each sample. Therefore, when viewed from the frequency domain, each TS-InSAR component should manifest distinct boundaries on the frequency domain. To this end, this method implements VMD to segregate each component within the frequency domain, decomposing trend, seasonality, and noise components into separate frequency bands.

In one embodiment, the noise component includes both random noises and outliers.

In one embodiment, a robust surface deformation monitoring method is provided, integrating variational mode decomposition (VMD) and GRU. With VMD, frequency priors are introduced and the original TS-InSAR data is decomposed and reconstructed, eliminating the influence of annual seasonal variations. With GRU, the noise component is removed from the TS-InSAR and the influence of the outliers is mitigated, so that the trend component that can intuitively reflect the surface deformation state is extracted.

By integrating VMD with GRU and incorporating frequency priors of TS-InSAR, the method of the subject invention not only effectively enhances the model's robustness to annual seasonal variations, but also mitigates the influence of outliers, which is critically important for improving the robustness and accuracy of continues and large-scale surface deformation monitoring.

In the following sections, the method for obtaining TS-InSAR is presented, introducing the architecture of the VMD-GRU model, results of experiments conducted on synthetic and real-world data to verify the robustness and effectiveness of the VMD-GRU method are provided, and the robustness of the model to annual seasonal variation, the effect of time series reconstruction on the model performance, the generalization of the method to different revisit periods, and the limitations of this method are discussed.

The robust method for continuous and large-scale surface deformation monitoring using TS-InSAR addresses the challenges posed by annual seasonal variations and noise, thereby offering highly accurate and reliable surface deformation data. The practical uses include natural hazard monitoring, environmental change detection, and infrastructure stability assessment.

The method integrates VMD and GRU to enhance the robustness and accuracy of TS-InSAR data analysis. VMD decomposes the original TS-InSAR data into three components: trend, seasonal, and noise. This decomposition helps eliminate the influence of annual seasonal variations. The seasonal component is subtracted from the original time series, and the GRU is then used to refine the reconstructed time series by removing noise and mitigating the influence of outliers. This process yields a trend component that accurately reflects the surface deformation.

Compared to the traditional InSAR measurement techniques, the VMD-GRU method of the subject invention offers enhanced robustness against annual seasonal variations and outliers. The existing methods, such as low-pass temporal filtering techniques including Gaussian and triangular filtering, heavily depend on parameter settings and may leave residual noise or obscure minor changes in the data. On the other hand, the VMD-GRU method of the subject invention, by introducing frequency priors and utilizing deep learning, significantly improves the accuracy and reliability of surface deformation monitoring over long-term and large-scale applications.

The subject invention is particularly relevant for natural hazard monitoring, environmental monitoring, and urban infrastructure management.

The method of the subject invention has been validated through experiments on both synthetic and real-world datasets, demonstrating the method's robustness and accuracy.

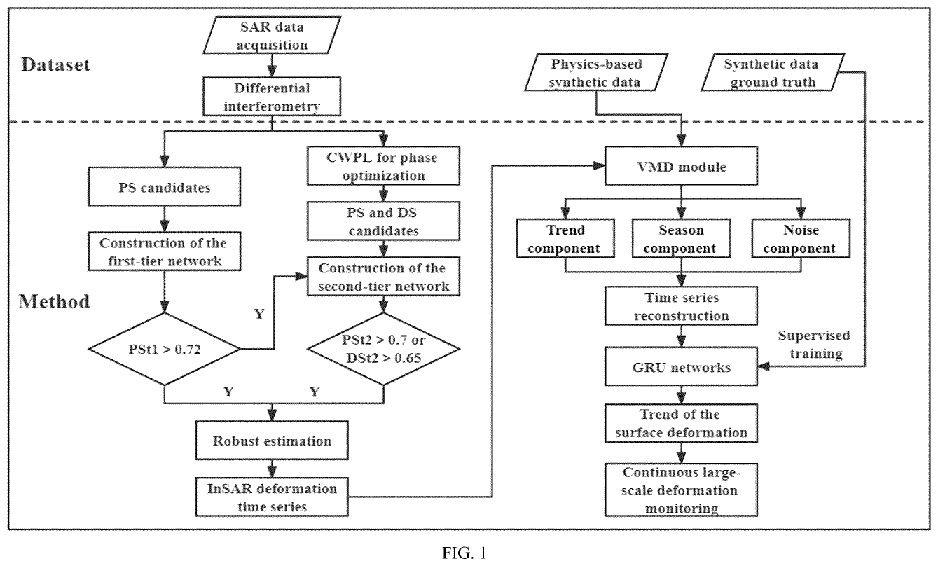

The acquisition process of time series data on surface deformation using robust multi-temporal InSAR is described below. Subsequently, details of the VMD-GRU method are provided and its potential to improve the robustness of TS-InSAR-based deformation monitoring is demonstrated. The overall workflow of the method is depicted in FIG. 1.

### Robust Multi-Temporal InSAR for Acquiring Time Series Data

A robust two-tier multi-temporal InSAR method is employed for the detection of Persistent Scatterer (PS) and distributed scatterer (DS) points to acquire time series data for surface deformation monitoring, as demonstrated in FIG. 1. The co-registration of SAR images is achieved through a purely geometric method, facilitated by SRTM DEM data [37]. This is subsequently followed by differential interferometry with a multi-look of 8×2. The design of a two-tier network is introduced for the identification of PS and DS, without the necessity for preliminary atmospheric removal across the whole area. PS candidates are handpicked with an amplitude dispersion value of 0.3, and subsequently linked within a densified Delaunay network. Following the phase differentiation of two connected PS candidates, the signal model is expressed as:

$$y = A Υ \qquad ( 1 )$$

where y=[y₁, . . . , y_{N}_{ₛ}]^{T} (Nₛ is the number of SAR images) represents the differential interferograms, [symbol] stands for a Nₛ×1 vector that includes the complex reflectivity of all objects equidistant to the SAR sensor, and A denotes the sensing matrix containing α(Δh,Δv) within its columns (Δh and Δv) represent the sampled relative height and deformation velocity between two PS candidates, respectively).

In one embodiment, after the differential interferometry step, the condition determining whether to extract PS candidates or perform CWPL is based on the maximum element in the absolute value of the estimated phase difference vector. If this maximum exceeds the threshold PSₜ₁=0.72, the arc is preserved for further analysis, which may involve extracting PS candidates; otherwise, the method of coherence-weighted phase-linking (CWPL) is performed for DS detection, particularly when the covariance matrix CCC is not positive definite or its inversion is unreliable.

The combined utilization of beamforming and a robust M-estimator facilitates the inversion of (1) and the estimation of [symbol] . Should the maximum element in abs ( [symbol] ) exceed the preset threshold of PSₜ₁=0.72, the arc is preserved, and the corresponding height and deformation velocity could be extracted. Relative parameters are then integrated via network adjustment, which includes the implementation of a ridge estimator to counteract potential ill-conditioning in the robust parameter integration.

In one embodiment, if PSₜ₁>0.72, the candidate point is processed in the second tier, and then the processed result of the second tier is judged by a threshold. When DSₜ₂>0.65 is also satisfied, the processed result is combined with the result of the first stage to form the final output result. On the other hand, if the condition PSₜ₁>0.7 or DSₜ₂>0.65 is not satisfied, the candidate point is not further processed and is not used for any further analysis.

The parameters PSₜ₁, PSₜ₂, and DSₜ₁ are thresholds of the process of Persistent Scatterer (PS) and Distributed Scatterer (DS) identification. In particular, PSₜ₁ is the threshold for determining whether the connection between two PS candidates should be preserved based on the maximum element in the absolute value of the estimated phase difference vector θ. If the maximum value exceeds PSₜ₁, the arc is preserved, and the corresponding height and deformation velocity are extracted. For example, the value of PSₜ₁ can be set at 0.72. Moreover, PSₜ₂ is the threshold for identifying additional PS points in the two-tier network step for handling multi-temporal InSAR data. PSₜ₂ is specifically used after the initial identification and extraction process to further refine and identify PS points. Similar to PSₜ₂, DSₜ₁ is for establishing temporal coherence thresholds for identifying DS points. The value for DSₜ₁ is generally set lower than the values of PSₜ₁ and PSₜ₂, reflecting the broader and less defined scatterer characteristics of DS in comparison with PS.

The most stable PSs are extracted from the densified Delaunay network, serving as a reference for the detection of further PS and DS points. The adoption of an omnidirectional point extension strategy allows for the progressive construction of local networks and multi-directional extension. For DS detection, SqueeSAR optimizes the differential phase through the application of the Broyden-Fletcher Goldfarb-Shanno method, which necessitates the inversion of covariance matrix C [38]. However, the inversion process may yield unreliable results if C is not positive definite, potentially introducing further errors. To rectify this issue, the optimal phase is calculated using coherence-weighted phase-linking (CWPL). Temporal coherence thresholds for identifying additional PSs and DSs are established at PSₜ₂=0.7 and DSₜ₂=0.65, respectively.

The line of sight (LOS) deformation velocity and time-series deformation of all PS and DS points are ultimately ascertained. For vertical surface deformation monitoring, the surface LOS deformation can be divided by cos (θ) (where θ is the incident angle) and converted into vertical deformation. In steep terrains, LOS deformation can be converted to the downward direction, using the slope gradient under the assumption that slope movements correspond to the downward direction.

### TS-InSAR Decomposition Based on VMD

VMD is an unsupervised signal decomposition method that excels in analyzing complex non-stationarity signals into a set of nearly orthogonal intrinsic modes. Through alternating minimization of the sum of the estimated spectral bandwidths, VMD effectively decomposes a signal by seeking the analytic signals of various modes with minimal bandwidths [39]. In contrast to the traditional methods such as Empirical Mode Decomposition and wavelet transform [41], VMD offers superior non-distortion, analytical solutions, and fewer parameters. Coupled with its capacity to deliver compact mode information and to analyze the inherent structures of complex datasets, VMD has found extensive use in image processing, biomedical signal analysis, and a variety of other fields [42], [43].

VMD operates based on the premise that a signal is a superposition of sub-signals or Intrinsic Mode Functions (IMF), each dominated by distinct frequencies. To qualify as an IMF, a function must meet two criteria: 1) The number of local extremum points and zero-crossing points across the entire function's time range must be either equal or differ by no more than one. 2) At any time point, the mean value of the envelope of the local maximum (upper envelope) and the envelope of the local minimum (lower envelope) must be zero. This assumption aligns with the decomposition of TS-InSAR into three distinct frequency components.

IMFs are defined as amplitude-modulated-frequency-modulated signals [44], expressible as:

$${s}_{k} ( t ) = {a}_{k} ( t ) cos ( {ϕ}_{k} ( t ) ) \qquad ( 2 )$$

where the phase φₖ(t) is non-decreasing, and the signal envelope aₖ(t) is non-negative. Furthermore, sₖ(t) is assumed to be a real signal, hence its analytical signal is:

$$s ( t ) = {s}_{k} ( t ) + j H [ {s}_{k} ( t ) ] \qquad ( 3 )$$

where H is the Hilbert transform [45], and its system transfer function is ĥ(w)=−jsgn(w).

Under the premise of VMD, all components are deemed narrow-band signals concentrated around their individual center frequencies. Thus, VMD establishes a constrained optimization problem based on the narrowband condition of the component, facilitating the estimation of the signal component's center frequency and the corresponding component's reconstruction. This optimization problem can be mathematically represented as:

$${min}_{\{ {u}_{k} \} , \{ {ω}_{k} \}} \{ {Σ}_{k} {‖ {\partial }_{l} [ ( δ ( t ) + j π l ) * {u}_{k} ( l ) ] {e}^{- j {ω}_{k} l} ‖}_{2}^{2} \} \qquad ( 4 )$$

$$s . t . {Σ}_{k} {u}_{k} ( l ) = f$$

where f denotes the input signal, uₖ represents the k^{th} component decomposed from signal f, ωₖ denotes the centre frequency of component uₖ, δ(t) is the Dirac delta function, * denotes convolution operation,

$$\frac{\partial }{\partial t} [ \cdot ]$$

calculates the differential of [·] with respect to time t, |·|₂ computes the 2-norm of [·].

The optimization problem seeks to minimize the sum of Hilbert transform smoothness of all components

$$\vert \frac{\partial }{\partial t} [ ( δ ( t ) + j π t ) * {u}_{k} ( t ) ] {e}^{- j {ω}_{k} t} {\vert}_{2}^{2}$$

under the constraint that the sum of components is equal to the original signal f(Σₖ uₖ(t)=f). To solve this problem, the above-equality-constrained optimization problem can be transformed into an unconstrained optimization problem through an augmented Lagrangian [46], [47], expressed as:

$$L ( \{ {u}_{k} \} , \{ {ω}_{k} \} , λ ) : = α {\sum }_{k} {‖ {\partial }_{t} [ ( δ ( t ) + \frac{j}{π t} ) * {u}_{k} ( t ) ] {e}^{- j {ω}_{k} t} ‖}_{2}^{2} + {‖ f ( t ) - {Σ}_{k} {u}_{k} ( t ) ‖}_{2}^{2} + 〈 λ ( t ) , f ( t ) - {Σ}_{k} {u}_{k} ( t ) 〉 \qquad ( 5 )$$

The solution to this constrained problem can be obtained via the alternate direction method of multipliers (ADMM) [48], [49], [50], which proposes updating one of the variables while keeping the other two variables fixed, as represented in the following equations:

$${u}_{k}^{n + 1} = {arg min}_{{u}_{k}} L ( \{ {u}_{i < k}^{n + 1} \} , \{ {ω}_{k}^{n} \} , {λ}^{n} ) ; \qquad ( 6 )$$

$${ω}_{k}^{n + 1} = {arg min}_{{ω}_{k}} L ( \{ {u}_{k}^{n} \} , \{ {ω}_{i < k}^{n + 1} \} , {λ}^{n} ) ;$$

$${λ}^{n + 1} = {λ}^{n} + ρ ( f ( t ) - {\sum }_{k} {u}_{k}^{n + 1} ( t ) ) .$$

VMD, bolstered by a solid mathematical framework, essentially operates as an adaptive optimal Wiener wave filter group. The specification of its target IMF number significantly impacts its decomposition accuracy [51], [43]. For TS-InSAR data, the frequency difference of the three components of trend, season, and noise is introduced into the model as prior knowledge, setting the corresponding number of target IMFs to three. This ensures that the decomposition of TS-InSAR data is underpinned by a clear physical basis. Further details on VMD's implementation can be found in subsequent sections.

### Integrated VMD-GRU Method

The integration of VMD and GRU methods, as depicted in

FIG. 1, forms a potent approach for monitoring large-scale surface deformation, exhibiting improved robustness and precision.

This subsection delves into the rationale behind this integration and provides insights into the effective merger of the two methods. The chief purpose behind amalgamating VMD with GRU is the augmentation of the robust qualities of both time series data processing methods, as well as offsetting their respective limitations. Among them, VMD facilitates the decomposition of TS-InSAR data into multiple frequency signals, enabling the identification of various deformative components in the data. However, VMD's effectiveness may be compromised by high noise and mode mixing in the decomposition results due to its unsupervised nature. Such limitations can result in decreased decomposition accuracy and misinterpretation of similar frequency components.

In high-noise environments, the accuracy of the decomposition outcomes diminishes, leading to the potential fusion of similar but distinct frequency components into one mode, or the fragmentation of a single mode into various components. This limitation could cause the failure of VMD in accurately capturing complicated, nonlinear deformation patterns, particularly in prolonged monitoring scenarios. However, VMD offers the significant benefit of removing annual seasonal variances in regions experiencing significant atmospheric delay, as it uses the prior knowledge of specific seasonal signal frequency. On the other hand, GRU, a specialized type of Recurrent Neural Network (RNN), has demonstrated remarkable success in predicting time-series data with nonlinear patterns [27]. Although GRU performance is limited in non-stationarity time series, it can model the temporal dependency of a single component over a long period (G. Huang et al., 2021), making it ideal for continuous and large-scale monitoring of surface deformation. Thus, integrating VMD and GRU can result in a hybrid model with superior performance.

A layer of GRU with decay (GRU-D) is utilized to address the issue of potential missing values in TS-InSAR data. Subsequently, two layers of GRU further extract the features of the reconstructed time series, mapping the extracted features into separated trend components through multi-layer perception (MLP). The implementation details of GRU and GRU-D are presented in subsequent sections. To better utilize the contextual content of time series data for noise removal, all networks in the model are set to bidirectional connectivity [53]. The VMD-GRU model architecture is illustrated in FIG. 2.

As depicted in FIG. 2, the VMD-GRU model operates on two primary levels: reconstruction and decomposition. Initially, TS-InSAR data is decomposed into several IMFs via VMD, each IMF representing a distinct frequency band of the component. This can be mathematically represented as:

$$F ( t ) = {\sum }_{k = 1}^{K} {IMF}_{k} ( t ) + {R}_{t} \qquad ( 7 )$$

where F(t) represents the original TS-InSAR data, IMFₖ(t) denotes the k^{th} IMF and K signifies the total number of IMFs. Rₜ stands for the residual noise value post-decomposition. This value is typically minimal and is determined by the parameter τ in VMD, which is used to ascertain the convergence of VMD after numerous iterations. Based on the aforementioned decomposition outcomes, the IMF corresponding to the seasonal component IMFₛ is subtracted from the original time series, leading to the reconstruction of the original signal. Why this method of reconstructing first and then decomposing will be elaborated in the discussion section later. This computation can be represented as:

$$R e {c}_{ts} = F ( t ) - {IMF}_{s} . \qquad ( 8 )$$

In the decomposition stage, the reconstructed signal is fed into the stacked GRU networks for the extraction of trend components. Owing to the ability of GRU-D and GRU to handle complex temporal dependencies, the trend component can be extracted from the reconstructed signal. The effective combination of these methods exploits the feature extraction capability of VMD and the powerful temporal modeling capabilities of GRU, culminating in superior prediction performance. Furthermore, this model benefits from the application of separate GRU networks on each IMF, which aids in capturing distinct temporal patterns existing in different frequency bands. Consequently, the VMD-GRU method allows for more robust and precise monitoring of continuous and large-scale surface deformation.

### Materials and Methods

In this section, the efficacy of the VMD-GRU is elucidated through the analysis of synthetic data and real-world data from the Lantau Island and the Guangdong-Hong Kong-Macao Greater Bay Area (GBA). The performance of the VMD-GRU method is juxtaposed against the traditional Gaussian filters and the existing GRU method.

### Experimental Data

The data used in the performance evaluation encompasses both synthetic and real-world data. The synthetic data, designed in line with (termed as GRU method in the following), are produced based on physical mechanism simulations tailored to the requirements of the deep learning model. The synthetic data comprises the amalgamation of three components: trend, season, and noise. Thus, the synthetic data X(t) can be formulated as follows:

$$X ( t ) = ( Trend ( t ) + Season ( t ) + Noise ( t ) ) \cdot M ( t ) \qquad ( 9 )$$

where Trend(t) represents the trend component, which may display linear, decelerating, or accelerating behavior as outlined by (Intrieri et al., 2018). The seasonal component is represented as Season(t). Noise(t) signifies the noise component. A binary mask matrix, M(t), indicates the possible missing values within the time series, a frequent occurrence in TS-InSAR data. GRU-D method aids in managing these missing values, thereby reducing their impact on the accuracy of deformation monitoring results.

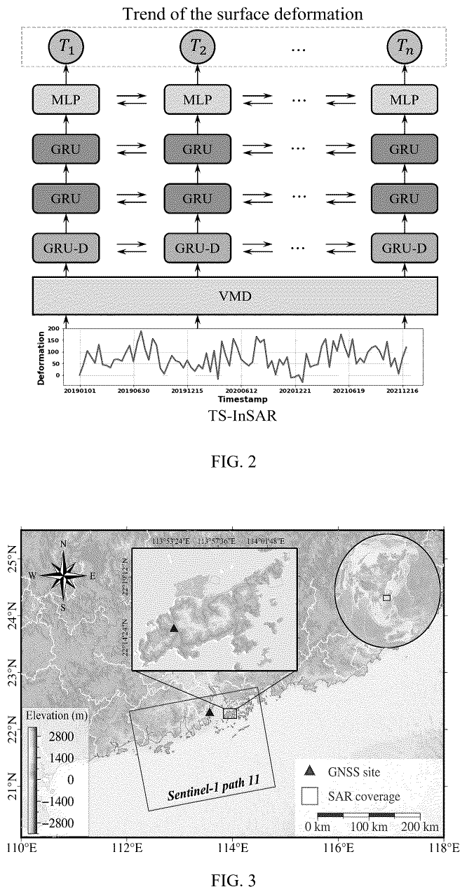

Synthetic datasets are fabricated as the reverse process of InSAR data acquisition according to physical mechanisms. Therefore, individual components and their ground truth values are annotated, thereby providing a quantitative metric for the performance evaluation of the VMD-GRU against other existing methods. In addition to the synthetic data, real-world InSAR data forms an integral part of the experimental datasets. To comprehensively assess the robustness of the VMD-GRU, Lantau Island (coastal areas with strong terrain) near Hong Kong airport and the GBA are selected as the study area, as shown in FIG. 3. These regions, located in the subtropical region of southern China, experience frequent cloudy and rainy weather, leading to the amplification of atmospheric noises in InSAR signals. Lantau Island is chosen to demonstrate the effectiveness of the method in coastal areas with strong terrain variations. Proximate to the Hong Kong Airport, whose Ts-InSAR data are used to validate the GRU method, Lantau Island exhibits significant topographical variations compared to the relatively flat Hong Kong airport, thereby contributing to stratified delays in TS-InSAR that cannot be ignored. Surface deformation monitoring data from a GNSS station on Lantau Island is obtained to validate the method's effectiveness in monitoring surface deformation trends. Additionally, to further verify the method's robustness on a larger spatial scale, data from the GBA, covering several cities and a GNSS station in Zhuhai city, is used.

Sentinel-1 SAR images for these areas, spanning from Jan. 1, 2019, to Dec. 27, 2021, are processed using the robust multi-temporal InSAR method to procure the time-series data of the measurement points within these regions. Ideally, satellites Sentinel-1A and Sentinel-1B collect SAR images at 12-day intervals, and their combined use allows for observations at 6-day intervals. A total of 88 SAR images are obtained at a minimum interval of 12 days due to the low sampling rate over Hong Kong. Accordingly, over the period from Jan. 1, 2019, to Dec. 27, 2021, with a 12-day interval, the number of SAR images is 92. However, with 4 (92-88) missing observations, the missing rate approximates 4.3%.

### Model Configuration and Training

The experiment configuration and execution utilize a Windows operating system, Python programming language, and the TensorFlow deep learning framework [54]. All experimentations are conducted on a Geforce GTX 3090 GPU, with 24 GB RAM and an Intel i7-11700KF CPU with 64 GB RAM. The training process for the VMD-GRU model is performed on a dataset including 60,000 synthetic time series in accordance with the synthetic dataset specifications of the construction of the traditional GRU method. The dataset includes 20,000 samples for each of decelerating, accelerating, and linear deformation trend types, inclusive of stable deformations. In the VMD-GRU method of the subject invention, both the GRU-D and GRU layers comprise 64 hidden units. A dropout rate of 0.2 is imposed on the GRU layers and the subsequent MLP to improve model generalization and prevent overfitting. The model parameters are optimized using the Adam method [55], with the aim of minimizing the mean squared error (MSE) loss. Early stopping is employed to identify the best weights for the model, with the validation dataset comprising 9,000 synthetic time series. All input time series are globally normalized within a range of −1 to 1 for consistency, while output supervisions retain their original values. The initial learning rate is set at 3×10⁻⁴ and the batch size for training and testing is fixed at 64.

### Evaluation on Synthetic Data

Since synthetic data is embedded with ground truth, it is an ideal tool for the quantitative evaluation of the VMD-GRU method. Utilizing the same configuration as the GRU method, 20,000 diverse synthetic time series are generated to test the VMD-GRU model and it is compared with other existing methods, including temporal Gaussian filtering with various standard deviation σ parameters and the GRU method. Temporal Gaussian filtering is a frequent choice for InSAR time series denoising, although it necessitates careful selection of the appropriate standard deviation σ parameter. The σ value is tested at 1, 2, 3, and 4 to empirically ascertain the optimal parameter choice for temporal Gaussian filtering. For missing values, the Gaussian filtering discards missing time steps, utilizing only available data within the filtering window for output. The GRU method directly employs the original TS-InSAR data as input. Its key divergence lies in its lack of VMD usage to introduce frequency priors for data reconstruction. Notably, separating deformation trends from raw TS-InSAR data is a sequence-to-sequence multi-output regression task, where output values are not independent.

Several machine learning algorithms inherently support this type of multiple-output regression, with decision trees being a popular example. Despite this, decision trees for multiple output regression may encounter limitations, as the relationship between inputs and outputs can become blocky or highly structured based on the training data. Furthermore, the performance is sensitive to tree depth. If the tree's maximum depth is set too high, it may overlearn the fine details of the training data and consequently overfit the noise. More importantly, traditional machine learning methods often struggle with optimization due to the interdependence of hundreds of output values, and thus are not selected as baselines for comparative experiments.

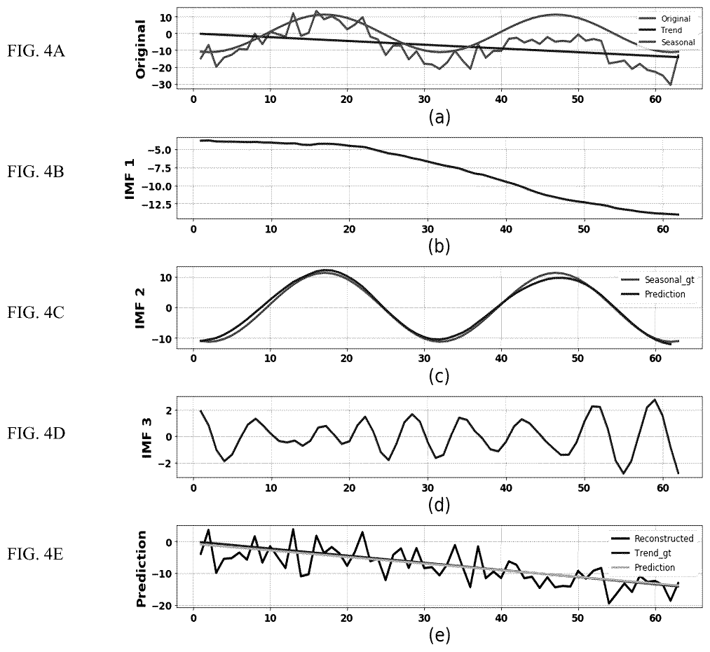

The quantitative results from the experiments on synthetic datasets are presented in Table I. Additionally, a visual representation of the synthetic time series data processing using VMD-GRU is provided in FIGS. 4A-4E, demonstrating the original signal reconstruction process and deformation trend extraction.

TABLE I
EVALUATION RESULTS ON THE
SYNTHETIC TESTING DATASET.

| | Gauss | | | | | |
|---|---|---|---|---|---|---|
| Metric | σ = 1 | σ = 2 | σ = 3 | σ = 4 | GRU | VMD-GRU |
| MSE | 8.842 | 5.053 | 5.442 | 8.518 | 3.528 | 3.287 |
| MAE | 2.352 | 1.781 | 1.850 | 2.311 | 1.485 | 1.522 |

The VMD-GRU method exhibits comparable performance to the traditional GRU method, as shown in the results in Table I. GRU-based methods significantly outpace temporal Gauss filtering methods, which are heavily dependent on appropriate parameter choice. In addition, when σ is 2, the Gaussian filter achieves the best performance, so when visualizing the trend estimation results, only σ equal to 2 is displayed.

The performance of the VMD-GRU method, as illustrated in FIGS. 4A-4E, shows promising aptitude in extracting seasonal components. Additionally, the deformation trend derived from the reconstructed signal aligns closely with the ground truth. It is worth mentioning that the synthetic data is generated following a physical mechanism assumption, in which there is no large change in the amplitude of the seasonal signal, and the annual seasonal variation is not fully considered. As such, the synthetic data can be viewed as a unique subset of real-world data where differences in annual-seasonal components are absent. The performance similarity of the VMD-GRU to the GRU method in such circumstances demonstrates the feasibility of the VMD-GRU method for continuous surface deformation monitoring based on TS-InSAR. The presence and impact of variations between annual seasons will be further explored through experiments detailed in the subsequent sections.

### Evaluation on Real-World Data

Unlike synthetic data, where the annotated ground truth can be leveraged as a reference, most of the real-world data are not manually annotated, but the spatial distribution of deformation can be qualitatively analyzed or validated using nearby GNSS stations or existing research. This section contains two areas, the validation on Lantau Island and the performance on GBA.

### Robustness to Annual Seasonal Variation

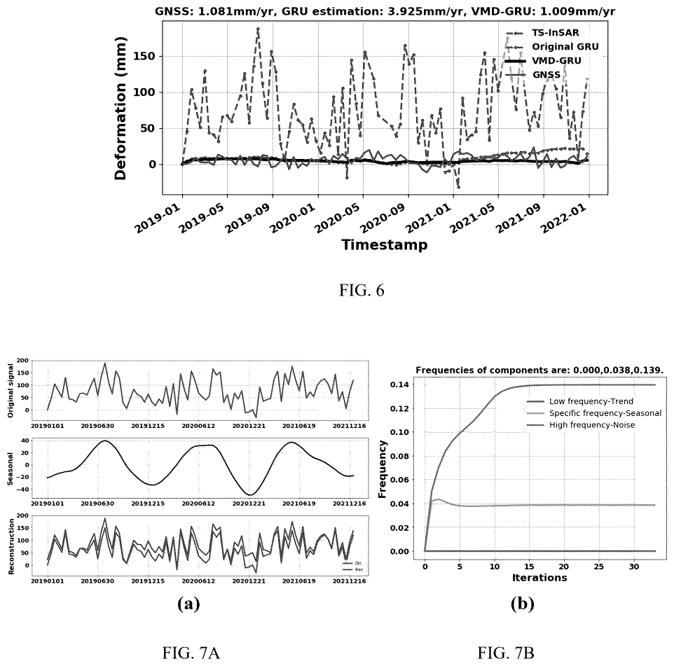

FIG. 6 reveals the widespread presence of annual differences in TS-InSAR through a comparison of TS-InSAR time series data and GNSS station measurement data. To assess the impact of annual seasonal differences, the synthetic data method used to train the traditional GRU method is modified, generating an additional 20,000 samples of synthetic data with varying seasonal amplitudes to evaluate the effectiveness of the existing methods. The synthetic data are assumed to comprise three periods, with the amplitude of the seasonality in each period set to differ. Trend and noise components continue to follow previous settings for synthetic simulation data. Table II provides a performance comparison of the VMD-GRU and existing comparative methods on synthetic data with annual seasonal differences.

TABLE II
EVALUATION RESULTS ON THE SYNTHETIC TESTING
DATASET WITH ANNUAL SEASONALITY CHANGE.

| | Gauss | | | | | |
|---|---|---|---|---|---|---|
| Metric | σ = 1 | σ = 2 | σ = 3 | σ = 4 | GRU | VMD-GRU |
| MSE | 11.329 | 8.662 | 8.102 | 8.340 | 6.528 | 3.937 |
| MAE | 5.667 | 6.131 | 3.063 | 4.283 | 4.875 | 2.010 |

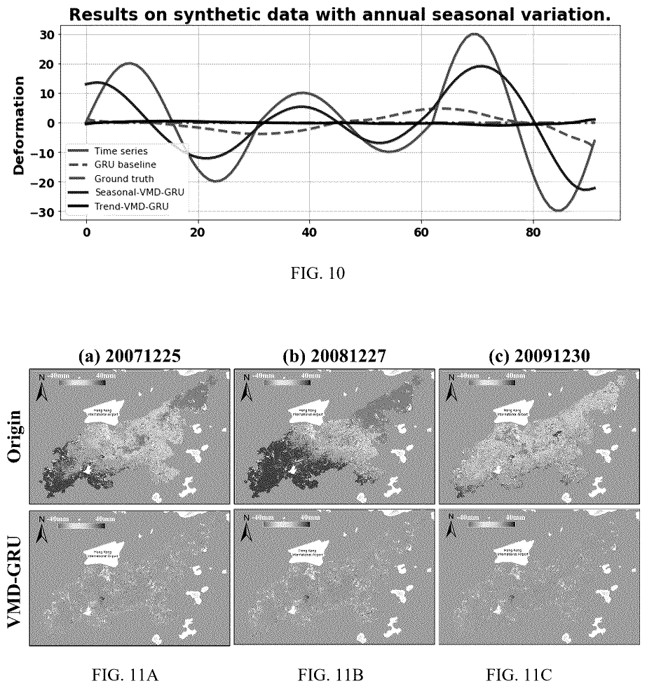

The results in Table II demonstrate that when an annual difference in the amplitude of the seasonal signal is present, the traditional GRU method, trained on a fixed amplitude, struggles to handle this change effectively. The performance of the Gaussian filter at different Isigma levels is significantly impacted by parameter settings, and no specific performance changes correspond to different \sigma levels. Although the performance of the VMD-GRU method declines relative to the fixed amplitude in Table I, it still significantly outperforms existing methods. An example of the outcomes on the synthetic dataset with annual seasonal variation is visualized in FIG. 10.

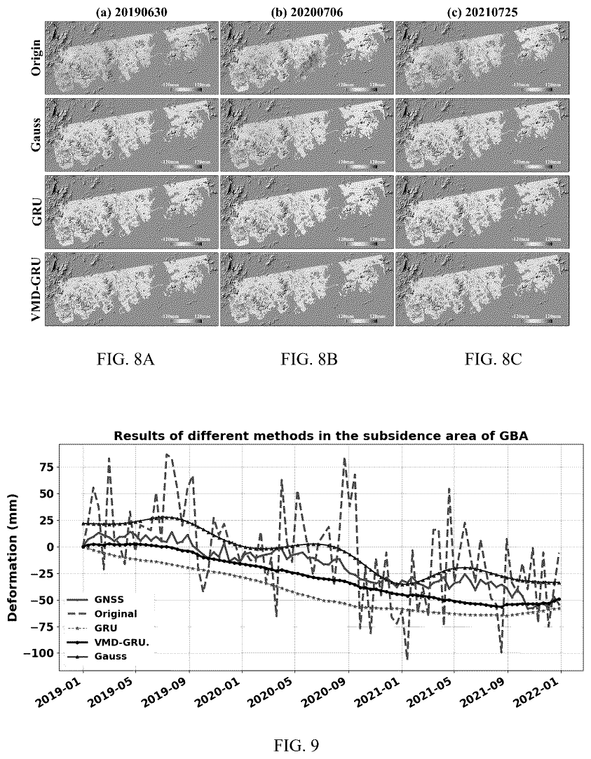

The results visualized in FIG. 10 highlight the superior robustness of the VMD-GRU model to annual seasonal variations. Although there are some differences between the seasonal components separated by VMD and the real seasonal components, the annual seasonal variation is fully reflected. Therefore, after the input time series is reconstructed by VMD, the annual seasonal variation is eliminated, and the seasonality in the reconstructed time series can be approximately considered as a constant that does not change with time, which can be easily removed by the GRU in subsequent processing. This robustness renders it more suitable for continues and large-scale surface deformation monitoring compared to the traditional GRU method. Interestingly, the traditional GRU model appears to more frequently align with the smallest amplitude situation in each year, utilizing this as the amplitude for every year. This pattern could potentially explain why the traditional GRU model assumes a V-shape when an annual-seasonal difference is presented in FIGS. 8A-8C.

### Reasons for Time Series Reconstruction

Inspection of FIGS. 4B and 4D reveals a certain degree of mode mixing between the trend component and the noise component following VMD decomposition. This indicates that direct utilization of VMD decomposition results as the trend component may lead to substantial error. This situation may arise from signal aliasing when VMD is engaged in components decomposition. In the context of InSAR data acquisition, the heterogeneity of atmospheric influence may contribute to outliers, which may originate from sporadic factors influenced by specific meteorological events such as typhoons. These outliers' frequency responses may display low-frequency characteristics similar to the trend signal, thereby leading to a mix of trend components and outliers. While the seasonal component, unlike the trend and noise components, is a signal that manifests around a particular center frequency, as FIG. 4C illustrates, i.e., the seasonal component is relatively stable.

Consequently, a data reconstruction method is employed, subtracting the seasonal component decomposed by VMD from the original time series. From a frequency domain perspective, its features are more distinct compared to the trend and noise components. By handling in this way, the influences of outliers and annual seasonal variations originally mixed together are separated. And it is more accurate to separately isolate the seasonal components and use them to reconstruct the input time series data rather than directly employing individual components. This approach leverages the frequency prior introduced by VMD to separate the components and taps into the GRU's exceptional nonlinear feature extraction capabilities. The robustness of the VMD-GRU method is corroborated by the previously presented experimental results on real-world data.

### Generalization to Different Revisit Periods

The real-world data used thus far to validate the VMD-GRU method are collected in the C-band by Sentinel-1, with a 12-day revisit period. One significant contribution of this method lies in introducing the frequency prior to each component in TS-InSAR to realize timing decomposition from a frequency domain perspective. This naturally raises the question of whether the method can also display strong robustness with different TS-InSAR data that have different revisit periods in various bands.

To address this issue, this method also used the L-band Advanced Land Observing Satellite (ALOS) to obtain the SAR data of Lantau Island from Jun. 24, 2007, to Jan. 2, 2011. The ALOS revisit period is 46 days, unlike the 12-day revisit period of Sentinel-1, which results in a significant shift in the central frequency corresponding to the seasonal components in TS-InSAR. The performance of VMD-GRU and existing methods on ALOS data is shown in FIGS. 11A-11C.

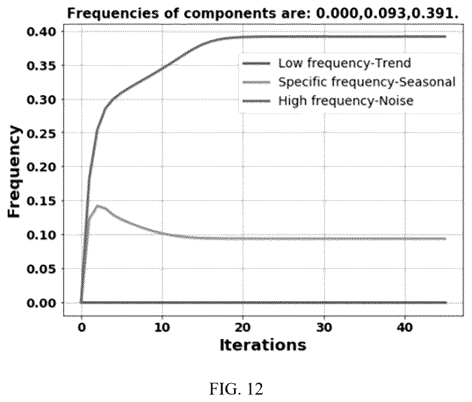

The periodicity of the ALOS TS-InSAR seasonal component, which has a revisit period of 46 days, is calculated to be 365/46-7.9, with a corresponding central frequency of approximately 0.126. The central frequency associated with the seasonal component shown in FIG. 12 is approximately 0.093, which is in close proximity. These outcomes demonstrate that the VMD-GRU approach is capable of effectively isolating seasonal components from the frequency domain of SAR data collected by satellites with varying revisit periods and across different bands, despite significant changes in center frequency and noise sources. This supplementary experiment on ALOS data further validates the robustness and generalization of the VMD-GRU method. For TS-InSAR data with different revisit periods in different bands, its frequency prior can also be introduced into the VMD-GRU model to improve the robustness and accuracy of continuous large-scale surface deformation monitoring.

### Limitations

While the VMD-GRU method advances the traditional GRU model by combining VMD and GRU to achieve continuous and large-scale surface deformation monitoring, it only processes the time series data of independent measurement points. It does not incorporate the spatial correlation information of the measurement points into the analysis, which could be significant for understanding local deformation mechanisms and exploring more robust and accurate monitoring. Moreover, there exists a certain degree of aliasing between the trend component and the noise component when using VMD to decompose TS-InSAR into various components. Despite the possibility of further separation by GRU, some remnants may persist. These remnants could be continuously amplified during long-term monitoring, potentially restricting the accuracy of surface deformation trend estimation.

The pseudocode of the implementation details of VMD is shown in Algorithm 1.

Algorithm 1 Pseudocode for VMD implementation with fixed K = 3
Require: Signal s(t), Convergence parameter a, Tolerance [symbol]
Ensure: Modes u₁(t), w₂(t), u₃(t)

| | |
|---|---|
| 1: | $Initialize {u}_{1}^{( 0 )} ( t ) , {u}_{2}^{( 0 )} ( t ) , {u}_{3}^{( 0 )} ( t ) , and {ω}_{1}^{( 0 )} , {ω}_{2}^{( 0 )} , {ω}_{3}^{( 0 )}$ |
| 2: | Set iteration u = 0 |
| 3: | repeat |
| 4: | $Solve the following subproblems for {u}_{1}^{( n + 1 )} , {u}_{2}^{( n + 1 )} , {u}_{3}^{( n + 1 )}$ |
| | respectively: |
| | ${u}_{1}^{( u + 1 )} = arg {min}_{\text{?}} ℛ \{ \int {\vert \text{?} ( ( s ( t ) - {u}_{2}^{( \text{?} )} ( t ) - {u}_{3}^{( \text{?} )} ( t ) ) {ε}^{- \text{?}} ) \vert}^{2} dt \}$ |
| | ${u}_{1}^{( u + 1 )} = arg {min}_{\text{?}} ℛ \{ \int {\vert \text{?} ( ( s ( t ) - {u}_{2}^{( \text{?} )} ( t ) - {u}_{3}^{( \text{?} )} ( t ) ) {ε}^{- \text{?}} ) \vert}^{2} dt \}$ |
| | ${u}_{1}^{( u + 1 )} = arg {min}_{\text{?}} ℛ \{ \int {\vert \text{?} ( ( s ( t ) - {u}_{2}^{( \text{?} )} ( t ) - {u}_{3}^{( \text{?} )} ( t ) ) {ε}^{- \text{?}} ) \vert}^{2} dt \}$ |
| 5: | Compute the new center frequencies by taking the first moment of |
| | the spretrum for each mode: |
| | ${ω}_{1}^{( \text{?} )} = \frac{\int ω {\vert {\text{?}}_{1}^{( n + 1 )} ( ω ) \vert}^{2} d ω}{\int {\vert {\text{?}}_{1}^{( n + 1 )} ( ω ) \vert}^{2} d ω}$ |
| | ${ω}_{2}^{( \text{?} )} = \frac{\int ω {\vert {\text{?}}_{2}^{( n + 1 )} ( ω ) \vert}^{2} d ω}{\int {\vert {\text{?}}_{2}^{( n + 1 )} ( ω ) \vert}^{2} d ω}$ |
| | ${ω}_{3}^{( \text{?} )} = \frac{\int ω {\vert {\text{?}}_{3}^{( n + 1 )} ( ω ) \vert}^{2} d ω}{\int {\vert {\text{?}}_{3}^{( n + 1 )} ( ω ) \vert}^{2} d ω}$ |
| 6: | Set n = n + 1 |
| 7: | until convergence criteria is met, |
| | $max \vert {ω}_{k}^{( \text{?} )} - {ω}_{k}^{( \text{?} )} \vert < \text{?} for all k$ |

[symbol]

indicates data missing or illegible when filed

GRU is a type of RNN that has proven effective in processing sequential data. However, they face challenges when dealing with missing or irregularly sampled data. To address these issues, the GRU-D method is provided, which incorporates additional information about missing data and time intervals between observations.

### B.1 Gated Recurrent Units (GRUs)

GRU is a simplified variant of LSTM units, another type of RNN. The GRU method uses gating units to modulate the flow of information, but unlike the LSTM, it does not have a separate memory cell and uses fewer gates, making it computationally more efficient.

The updated equations for a GRU are as follows:

$${r}_{t} = σ ( {W}_{r} {x}_{t} + {U}_{r} {h}_{t - 1} + {b}_{r} ) \qquad ( 10 )$$

$${z}_{t} = σ ( {W}_{z} {x}_{t} + {U}_{z} {h}_{t - 1} + {b}_{z} )$$

$$= tanh ( W {x}_{t} + U ( {r}_{t} ⊙ {h}_{t - 1} ) + b )$$

$${h}_{t} = ( 1 - {z}_{t} ) {h}_{t - 1} + {z}_{t} ⊙$$

where xₜ is the input at time t, hₜ₋₁ is the hidden state at the previous time step, σ is the sigmoid function, ⊙ denotes element-wise multiplication, and W, U, and b are learnable parameters.
B.2. GRU with Decay (GRU-D)

GRU-D extends the GRU method to handle missing value and irregular time intervals in time-series data. It introduces additional inputs: a masking vector to indicate missing values and a time interval vector to capture the time elapsed since the last observation.

The update equations for a GRU-D are similar to those of a GRU, but with additional transformations to handle missing data and irregular time intervals:

$${r}_{t} = σ ( {W}_{r} {\hat{x}}_{t} + {U}_{r} {\hat{h}}_{t - 1} + {V}_{r} {m}_{t} + {b}_{r} ) \qquad ( 11 )$$

$${z}_{t} = σ ( {W}_{z} {\hat{x}}_{t} + {U}_{z} {\hat{h}}_{t - 1} + {V}_{z} {m}_{t} + {b}_{z} )$$

$${\tilde{h}}_{t} = tanh ( W {\hat{x}}_{t} + U ( {r}_{t} ⊙ {\hat{h}}_{t - 1} ) + V {m}_{t} + b )$$

$${h}_{t} = ( 1 - {z}_{t} ) ⊙ {\hat{h}}_{t - 1} + {z}_{t} ⊙ {\tilde{h}}_{i}$$

where mt is the masking vector at time t, indicating the presence of missing values, and V is the time interval vector at time t, representing the time elapsed since the last observation.

Following are examples that illustrate procedures for practicing the invention. These examples should not be construed as limiting. All percentages are by weight and all solvent mixture proportions are by volume unless otherwise noted.

### Example 1—Validation on the Lantau Island

The Lantau Island, proximate to Hong Kong airport where the traditional GRU method is validated, has been selected as one of the study areas. This area is characterized by strong terrain in contrast to the airport's low terrain. The study area is depicted in FIG. 3, which also contains a GNSS station (represented by a blue triangle in FIG. 3). The surface deformation data gathered by this station, collected by the Nevada Geodetic Laboratory of the University of Nevada, Reno, are available for public access and serve as an empirical benchmark to validate the performance of different methods.

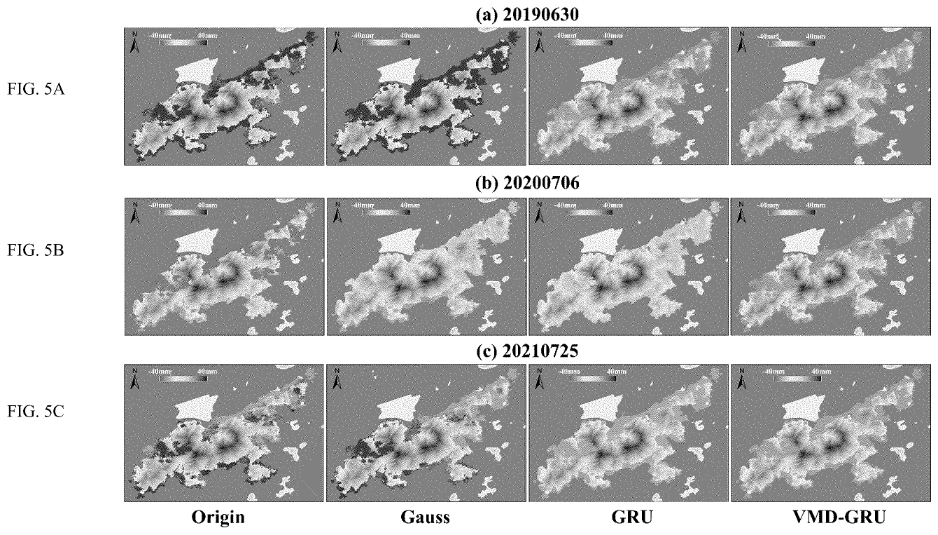

In an endeavor to validate the VMD-GRU method's robustness in strong terrain areas, Sentinel-1 SAR data of Lantau Island are processed using the Gauss filtering, the traditional GRU method and the VMD-GRU. The spatial distribution of cumulative deformation over different periods is showcased in FIGS. 5A-5C.

As revealed in FIGS. 5A and 5C, the traditional GRU method fails to yield effective results in regions with strong terrain. Unremoved seasonal variations accumulate in the trend component, manifesting an overall upward surface deformation trend. Contrarily, the trend component extracted by the VMD-GRU demonstrates commendable resilience to terrain changes. Temporal Gaussian filtering removes some noise interference but may also cause some trend components to be removed unnecessarily. In addition, it can be clearly seen in FIG. 5C that temporal Gaussian filtering cannot deal with the impact of strong terrain. As the altitude increases from west to east, the surface deformation appears an undue overall uplift. FIG. 5B shows an obvious outlier in TS-InSAR. The original signal suddenly dropped below 0. Although both temporal Gaussian filtering and the traditional GRU method have corrected this outlier to a certain extent, it can be seen that the deformation value increases with the elevation from west to cast, obviously there have been regional changes that should not have occurred. The traditional GRU method is affected by outliers, and the overall values are not robust. This highlights the challenges faced by the traditional GRU method in effectively managing outliers with contextual content of time series. Conversely, the VMD-GRU method displays strong robustness to outliers. It preprocesses outliers in the time domain while reconstructing the signal, thereby ensuring the accuracy of continuous monitoring.

To further evaluate the effectiveness of the method in the time domain, the data of a measurement point located near the GNSS station is extracted as an input. FIG. 6 illustrates the results of different methods on the time series data obtained from Lantau Island, including the traditional GRU method, VMD-GRU, and GNSS station's measurements, respectively. Among them, the deformation measured by the GNSS station is strictly quality-controlled by Nevada Geodetic Laboratory solutions, and thus can be considered a true deformation of the Earth's surface [56]. But this measure also incorporates seasonal variation, so the average deformation rate can be considered for closely reflecting the deformation trend.

Observing the results presented in FIG. 6, annual seasonal variations are discernible in the original time series data across three years from 2019 to 2021. The traditional GRU method fails to separate the trend component from the seasonal component fully when extracting the trend component. Consequently, residual seasonal signals accumulate in the trend component, leading to an overall V-shaped trend component. Also as shown in FIG. 6, the annual average deformation velocity estimated by GNSS is 1.081 mm/yr, traditional GRU method is 3.925 mm/yr, and VMD-GRU is 1.009 mm/yr. VMD-GRU has achieved a level far exceeding the traditional GRU method and is closer to the estimated value of GNSS.

Further, the VMD's decomposition results for the time series data mentioned above are depicted in FIGS. 7A-7B. FIG. 7A illustrates the original time series, the seasonal components decomposed by VMD, and the reconstructed time series from top to bottom. FIG. 7B exhibits the spectrum diagram during the decomposition process of each component, signifying the convergence process of the VMD decomposition signal from the perspective of the frequency domain. When it finally converges, the frequency of the corresponding seasonal signal is approximately 0.038, and its corresponding period is about 26, which is highly consistent with the acquired TS-InSAR data period. Given Sentinel-1's revisit period of 12 days, the theoretical year encompasses about 30 timestamps. This corresponds to a frequency of about 0.033, with an error of about 6.1% ((0.033−0.035)/0.033) relative to the seasonal frequency of VMD decomposition. This may be due to the existence of missing values, small differences between the frequency of the seasonal component of the VMD decomposition and the true frequency.

### Example 2—Performance on GBA Data

After demonstrating the effectiveness of the VMD-GRU method in areas with strong terrain, further validation is performed in the context of the GBA, to confirm the model's robustness in large-scale surface deformation monitoring. The study area in GBA is marked by a red box in FIG. 3, and the performance of the various methods on GBA data is presented in FIGS. 8A-8C.

The substantial spatial inhomogeneity presents in the original data (topmost row of FIGS. 8A-8C) of the large-scale GBA. The temporal Gaussian filtering significantly suppresses the noise signal, yet it also runs the risk of unnecessarily removing portions of the deformation signal. In addition, temporal Gaussian filtering can only eliminate noise that obeys random distribution from the time series, and it is effective for the noise effect caused by strong terrain, and there is still a large amount of noise remaining in the mountainous area of the GBA.

The implementation of the traditional GRU method presents a substantial improvement in spatial inhomogeneity, even though large, interconnected deformation regions endure. Even certain areas in Hong Kong previously exhibiting minor deformation are misinterpreted as uplift by the traditional GRU method. In terms of spatial distribution, the traditional GRU method's impact resembles the effect of temporal Gaussian filtering with a standard deviation (σ) of 2, corroborating the findings of prior research [32]. Following the VMD-GRU, the surface deformation trend remains largely unaffected by topography. Additionally, relevant settlements, such as those in Zhuhai (FIG. 8B, red area of the origin), which align with prior studies (P. Ma et al., 2019), are well preserved within the VMD-GRU results. This emphasizes the utility of VMD-GRU in preserving important deformation information while effectively managing spatial inhomogeneities and noise effects. FIG. 9 presents the results of different methods in the subsidence area of GBA. It can be seen from the results that the estimation obtained by VMD-GRU are closer to the data obtained by GNSS stations than the temporal Gaussian filtering and the traditional GRU method.

The empirical experiments conducted on synthetic data, Lantau Island data, and GBA data demonstrate that the VMD-GRU exhibits formidable robustness against time-series signals superimposed by multiple components, noise, and strong terrain. This robustness is immensely valuable for the continuous and large-scale monitoring of surface deformation.

The embodiments of the subject invention offer several significant advantages over the existing InSAR measurement techniques, focusing on its robustness, scalability, and broader application prospects:

### 1. Enhanced Robustness for InSAR Monitoring:

Seasonal Variations and Noise Mitigation: By integrating Variational Mode Decomposition (VMD) and Gated Recurrent Units (GRU), the method effectively removes annual seasonal variations and mitigates noise. This results in more accurate and reliable deformation data, crucial for precise surface monitoring.

Outlier Handling: The VMD-GRU method is particularly robust against outliers, which are common in InSAR data due to atmospheric anomalies or instrumental errors. This robustness ensures the integrity of the monitoring data over time.

### 2. Advantages Over Longer Term and Larger Scales:

Continuous Monitoring: The method supports continuous long-term monitoring, providing consistent and high-resolution data over extended periods. This is essential for detecting slow or subtle surface deformations that may indicate underlying geological or environmental changes.

Large-Scale Application: The method is designed to handle large-scale surface deformation monitoring, making it suitable for wide-area applications such as regional or national scale hazard assessment and environmental monitoring. It provides comprehensive coverage and detailed insights, outperforming existing techniques limited by spatial or temporal constraints. Here, the term “large-scale” refers to vast geographical areas monitored for surface deformations, ranging from several square kilometers to thousands, often encompassing entire regions or significant infrastructure projects.

### 3. Broader Application Prospects:

Natural Hazard Monitoring: The method's accuracy and robustness make it ideal for monitoring natural hazards like earthquakes, landslides, and volcanic activities. It enables early detection and warning, potentially saving lives and reducing economic losses.

Environmental and Urban Applications: It is highly valuable for monitoring subsidence due to groundwater extraction, mining activities, and the impacts of climate change on glaciers and permafrost. In urban settings, it ensures the stability and safety of infrastructure such as buildings, bridges, and tunnels, supporting maintenance and development projects.

Commercial Viability: With the growing demand for reliable geospatial data, this method has significant commercial potential. It caters to industries such as civil engineering, environmental management, and urban planning, providing them with an advanced tool for surface deformation monitoring.

Overall, the VMD-GRU method of the subject invention represents a significant advancement in InSAR technology, offering superior robustness, scalability, and broader applicability. Its ability to deliver accurate, long-term, and large-scale monitoring data makes it an invaluable tool for various industries and applications, positioning it as a leading solution in the field of surface deformation monitoring.

A comprehensive search of the relevant databases, i.e., Web of Science, using the specified keywords yielded no existing research that combines InSAR, deformation monitoring, VMD, and GRU. However, searching with the keywords InSAR, deformation monitoring, and GRU retrieved a manuscript entitled “Landslide Risk Evaluation in Shenzhen Based on Stacking Ensemble Learning and InSAR”. The present invention differs significantly from the “Landslide Risk Evaluation in Shenzhen” article in its focus, methodology, and application. The retrieved article uses a stacking ensemble learning model incorporating CNN, MLP, GRU, and SVM regression for generating a landslide susceptibility map and evaluating landslide vulnerability. It integrates various data sources, including topography, geology, human activities, precipitation, and vegetation indices, to assess landslide risk.

In contrast, the subject invention focuses on a robust method for continuous and large-scale surface deformation monitoring using time-series Interferometric Synthetic Aperture Radar (TS-InSAR) data. The primary innovation lies in the integration of Variational Mode Decomposition (VMD) and Gated Recurrent Units (GRU) to enhance the robustness and accuracy of the monitoring data.

### Advantages of the Subject Invention Include:

1.Specificity to Deformation Monitoring: The subject invention specifically targets surface deformation monitoring, offering a more tailored approach to identifying and analyzing surface changes over time.
2.Robust Data Decomposition: By using VMD, the invention effectively decomposes TS-InSAR data into trend, seasonal, and noise components, providing a clearer understanding of surface deformation by removing annual seasonal variations and noise.
3.Enhanced Accuracy with GRU: The integration of GRU refines the reconstructed data, mitigating the impact of outliers and further enhancing the accuracy of the deformation monitoring results.
4.Scalability and Long-term Monitoring: The method is designed for continuous and large-scale applications, making it suitable for long-term monitoring projects and wide-area assessments.
5.Broader Application Prospects: While the retrieved manuscript focuses on landslide risk in a specific region, the present invention has broader applicability in natural hazard monitoring, environmental management, and infrastructure stability across various regions and contexts.

The combined use of VMD and GRU in the present invention represents a novel approach in the field of InSAR-based deformation monitoring, offering significant improvements in robustness and accuracy over existing methods.

This method of the subject invention advances the understanding of large-scale surface deformation monitoring through the development and application of the VMD-GRU model. Building on the foundation of the traditional GRU method, this study proposes a robust surface deformation monitoring method integrating VMD and GRU and explores the introduction of physics-based prior knowledge to existing deep learning model. This integration has demonstrated superior robustness to outliers and annual seasonal variations, thereby improving continues and large-scale monitoring potential. Several key conclusions can be drawn from the study:
The VMD-GRU model is more robust to outlier and annual seasonal variations compared to the traditional GRU method, demonstrating its applicability in continuous and large-scale surface deformation monitoring.
The annual seasonal variation, as one of the core factors affecting the accuracy of the existing GRU method, will lead to the accumulation of incompletely separated seasonal components into the trend component, thereby causing errors. This shortcoming can be solved well by introducing the frequency priors of each component in the VMD-GRU model.
Mode mixing, between the trend component and the noise component, exists after VMD decomposition, suggesting that direct use of VMD decomposition results may cause substantial error. Instead, the VMD-GRU model of reconstructing the input signal and then inputting it into the GRU can effectively improve the robustness of continuous and large-scale surface deformation monitoring.
The VMD-GRU method has good robustness and generalization and can be well extended to SAR satellites with different revisit periods in different bands when the revisit period is fixed, thus realizing continuous and wide-range ground deformation monitoring across different satellites.

The VMD-GRU method may be extended to incorporate spatial correlation information of the measurement points, which could significantly enhance the understanding of local deformation mechanisms and aid in the development of more robust and accurate monitoring methods. In addition, further exploration is necessary to address the existing aliasing between the trend component and the noise component, which may impact the estimation of surface deformation trends. This research could involve the development of more sophisticated models or techniques to further separate the components and reduce the amplification of remnants during long-term monitoring.

All patents, patent applications, provisional applications, and publications referred to or cited herein are incorporated by reference in their entirety, including all figures and tables, to the extent they are not inconsistent with the explicit teachings of this specification.

### EXEMPLARY EMBODIMENTS

Embodiments of the subject invention include, but are not limited to, the following exemplified embodiments:
Embodiment 1. A surface deformation monitoring method based on time-series InSAR (TS-InSAR), comprising:
   acquiring Synthetic Aperture Radar (SAR) data;
   performing differential interferometry;
   performing a robust two-tier multi-temporal InSAR method for detection of Persistent Scatterer (PS) and Distributed Scatterer (DS) candidates to acquire time series data for surface deformation monitoring;
   performing a variational mode decomposition (VMD) method to decompose TS-InSAR data into a plurality of components;
   reconstructing time series data;
   performing a gated recurrent unit (GRU) method;
   extracting trend of surface deformation; and
   performing continuous large-scale deformation monitoring.
Embodiment 2. The method of embodiment 1, wherein the performing a robust two-tier multi-temporal InSAR method comprises determining whether condition 1 is satisfied.
Embodiment 3. The method of embodiment 2, wherein if condition 1 is satisfied, more stable Persistent Scatterer (PS) candidates are identified to serve as reference.
Embodiment 4. The method of embodiment 3, further comprising constructing a first-tier network.
Embodiment 5. The method of embodiment 4, further comprising determining whether PSₜ₁ is greater than a first preset value.
Embodiment 6. The method of embodiment 5, further comprising: if PSt1 is smaller than or equal to the first preset value, then constructing a second-tier network.
Embodiment 7. The method of embodiment 6, further comprising determining whether PSt2 is greater than a second preset value and DSt2 is greater than a third preset value.
Embodiment 8. The method of embodiment 7, further comprising: if PSt2 is greater than the second preset value and DSt2 is greater than the third preset value, then performing a robust estimation method, and performing InSAR deformation of time-series.
Embodiment 9. The method of embodiment 6, further comprising: if PSt1 is greater than the first preset value, then performing the robust estimation method and performing the InSAR deformation of time-series.
Embodiment 10. The method of embodiment 2, further comprising: if condition 1 is not satisfied, then performing a coherence-weighted phase-linking (CWPL) method for phase optimization.
Embodiment 11. The method of embodiment 10, further comprising identifying more PS candidates and DS candidates.
Embodiment 12. The method of embodiment 11, further comprising performing the constructing a second-tier network.
Embodiment 13. The method of embodiment 12, further comprising determining whether PSt2 is greater than a second preset value and DSt2 is greater than a third preset value.
Embodiment 14. The method of embodiment 13, further comprising: if PSt2 is greater than the second preset value and DSt2 is greater than the third preset value, performing the robust estimation method and performing the InSAR deformation of time-series.
Embodiment 15. The method of embodiment 1, wherein the VMD method receives physics-based synthetic data as an input.
Embodiment 16. The method of embodiment 1, wherein the plurality of components include a trend component, a season component, and a noise component.
Embodiment 17. The method of embodiment 16, wherein the reconstructing time series comprises reconstructing time series data by removing the seasonal component.
Embodiment 18. The method of embodiment 1, wherein the GRU method receives synthetic data ground truth as an input.
Embodiment 19. The method of embodiment 1, wherein the performing a GRU method comprises refining reconstructed TS-InSAR data by the GRU method to eliminate noise and outliers.
Embodiment 20. A non-transitory computer readable medium having stored therein program instructions executable by a computing system to cause the computing system to perform a surface deformation monitoring method based on time-series InSAR (TS-InSAR), the method comprising:
   acquiring Synthetic Aperture Radar (SAR) data;
   performing differential interferometry;
   performing a robust two-tier multi-temporal InSAR method for detection of Persistent Scatterer (PS) and Distributed Scatterer (DS) candidates to acquire time series data for surface deformation monitoring;
   performing a variational mode decomposition (VMD) method to decompose TS-InSAR data into a plurality of components;
   reconstructing time series data;
   performing a gated recurrent unit (GRU) method;
   extracting trend of surface deformation; and
   performing continuous large-scale deformation monitoring.
Embodiment 21. The non-transitory computer readable medium of embodiment 20, wherein the performing a robust two-tier multi-temporal InSAR method comprises determining whether condition 1 is satisfied.
Embodiment 22. The non-transitory computer readable medium of embodiment 21, wherein if condition 1 is satisfied, more stable Persistent Scatterer (PS) candidates are identified to serve as reference.
Embodiment 23. The non-transitory computer readable medium of embodiment 22, further comprising constructing a first-tier network.
Embodiment 24. The non-transitory computer readable medium of embodiment 23, further comprising determining whether PSₜ₁ is greater than a first preset value.
Embodiment 25. The non-transitory computer readable medium of embodiment 24, further comprising: if PSₜ₁ is smaller than or equal to the first preset value, then constructing a second-tier network.
Embodiment 26. The non-transitory computer readable medium of embodiment 25, further comprising determining whether PSt2 is greater than a second preset value and DSt2 is greater than a third preset value.
Embodiment 27. The non-transitory computer readable medium of embodiment 26, further comprising: if PSt2 is greater than the second preset value and DSt2 is greater than the third preset value, then performing a robust estimation method, and performing InSAR deformation of time-series.
Embodiment 28. The non-transitory computer readable medium of embodiment 25, further comprising: if PSt1 is greater than the first preset value, then performing the robust estimation method and performing the InSAR deformation of time-series.
Embodiment 29. The non-transitory computer readable medium of embodiment 21, further comprising: if condition 1 is not satisfied, performing a coherence-weighted phase-linking (CWPL) method for phase optimization.
Embodiment 30. The non-transitory computer readable medium of embodiment 29, further comprising identifying more PS candidates and DS candidates.
Embodiment 31. The non-transitory computer readable medium of embodiment 30, further comprising performing the constructing a second-tier network.
Embodiment 32. The non-transitory computer readable medium of embodiment 31, further comprising determining whether PSt2 is greater than a second preset value and DSt2 is greater than a third preset value.
Embodiment 33. The non-transitory computer readable medium of embodiment 32, further comprising: if PSt2 is greater than the second preset value and DSt2 is greater than the third preset value, performing the robust estimation method and performing the InSAR deformation of time-series.
Embodiment 34. The non-transitory computer readable medium of embodiment 20, wherein the VMD method receives physics-based synthetic data as an input.
Embodiment 35. The non-transitory computer readable medium of embodiment 20, wherein the plurality of components include a trend component, a season component, and a noise component.
Embodiment 36. The non-transitory computer readable medium of embodiment 35, wherein the reconstructing time series comprises reconstructing time series data by removing the seasonal component.
Embodiment 37. The non-transitory computer readable medium of embodiment 20, wherein the GRU method receives synthetic data ground truth as an input.
Embodiment 38. The non-transitory computer readable medium of embodiment 20, wherein the performing a GRU method comprises refining reconstructed TS-InSAR data by the GRU method to eliminate noise and outliers.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] Festa, D., Bonano, M., Casagli, N., Confuorto, P., De Luca, C., Del Soldato, M., Lanari, R., Lu, P., Manunta, M., Manzo, M., et al. (2022). Nation-wide mapping and classification of ground deformation phenomena through the spatial clustering of p-SBAS InSAR measurements: Italy case study. ISPRS Journal of Photogrammetry and Remote Sensing, 189, 1-22. doi: 10.1016/j.isprsjprs.2022.04.022
[2] Lu, Z., Kwoun, O., & Rykhus, R. (2007). Interferometric synthetic aperture radar (InSAR): Its past, present and future. Photogrammetric Engineering and Remote Sensing, 73(3), 217. doi: 10.1016/j.isprsjprs.2022.04.022
[3] Ma, Z., Liu, J., Aoki, Y., Wei, S., Liu, X., Cui, Y., Hu, J., Zhou, C., Qin, S., Huang, T., et al. (2022). Towards big SAR data era: An efficient sentinel-1 near-real-time InSAR processing workflow with an emphasis on co-registration and phase unwrapping. ISPRS Journal of Photogrammetry and Remote Sensing, 188, 286-300. doi: 0.1016/j.isprsjprs.2022.04.013
[4] Yu, B., She, J., Liu, G., Ma, D., Zhang, R., Zhou, Z., & Zhang, B. (2022). Coal fire identification and state assessment by integrating multitemporal thermal infrared and InSAR remote sensing data: A case study of midong district, urumqi, china. ISPRS Journal of Photogrammetry and Remote Sensing, 190, 144-164. doi: 10.1016/j.isprsjprs.2022.06.007
[5] Zhang, Z., Zeng, Q., & Jiao, J. (2022). Deformations monitoring in complicated-surface areas by adaptive distributed scatterer InSAR combined with land cover: Taking the jiaju landslide in danba, china as an example. ISPRS Journal of Photogrammetry and Remote Sensing, 186, 102-122. doi: 10.1016/j.isprsjprs.2022.02.004
[6] Ferretti, A., Prati, C., & Rocca, F. (2001). Permanent scatterers in SAR interferometry. IEEE Transactions on Geoscience and Remote Sensing, 39(1), 8-20. doi: 10.1109/36.898661
[7] Osmanoğlu, B., Sunar, F., Wdowinski, S., & Cabral-Cano, E. (2016). Time series analysis of InSAR data: Methods and trends. ISPRS Journal of Photogrammetry and Remote Sensing, 115, 90-102. doi: 10.1016/j.isprsjprs.2015.10.003
[8] Zhao, Q., Ma, G., Wang, Q., Yang, T., Liu, M., Gao, W., Falabella, F., Mastro, P., & Pepe, A. (2019). Generation of long-term InSAR ground displacement time-series through a novel multi-sensor data merging technique: The case study of the shanghai coastal area. ISPRS Journal of Photogrammetry and Remote Sensing, 154, 10-27. doi: 10.1016/j.isprsjprs.2019.05.005
[9] Kirui, P. K., Reinosch, E., Isya, N., Riedel, B., & Gerke, M. (2021). Mitigation of atmospheric artefacts in multi temporal InSAR: A review. PFG-Journal of Photogrammetry, Remote Sensing and Geoinformation Science, 89, 251-272. doi: 10.1007/s41064-021-00138-z
[10] Kirui, P. K., Riedel, B., & Gerke, M. (2022). Multi-temporal InSAR tropospheric delay modelling using tikhonov regularization for sentinel-1 c-band data. ISPRS Open Journal of Photogrammetry and Remote Sensing, 6, doi: 100020. 10.1016/j.ophoto.2022.100020
[11] Schlögl, M., Widhalm, B., & Avian, M. (2021). Comprehensive time-series analysis of bridge deformation using differential satellite radar interferometry based on sentinel-1. ISPRS Journal of Photogrammetry and Remote Sensing, 172, 132-146. doi: 10.1016/j.isprsjprs.2020.12.001
[12] Hu, F., Wang, F., Ren, Y., Xu, F., Qiu, X., Ding, C., & Jin, Y. (2022). Error analysis and 3D reconstruction using airborne array InSAR images. ISPRS Journal of Photogrammetry and Remote Sensing, 190, 113-128. doi: 10.1016/j.isprsjprs.2022.06.005
[13] Ma, P., Wang, W., Zhang, B., Wang, J., Shi, G., Huang, G., Chen, F., Jiang, L., & Lin, H. (2019). Remotely sensing large- and small-scale ground subsidence: A case study of the guangdong-hong kong-macao greater bay area of china. Remote Sensing of Environment, 232, 111282. doi: 10.1016/j.rse.2019.111282
[14] Hanssen, R. F. (2001). Radar interferometry: Data interpretation and error analysis (Vol. 2). Springer Science & Business Media. doi: 10.1007/0-306-47633-9
[15] Bekaert, D., Walters, R., Wright, T., Hooper, A., & Parker, D. (2015). Statistical comparison of InSAR tropospheric correction techniques. Remote Sensing of Environment, 170, 40-47. doi: 10.1016/j.rse.2015.08.035
[16] Fattahi, H., & Amelung, F. (2015). InSAR bias and uncertainty due to the systematic and stochastic tropospheric delay. Journal of Geophysical Research: Solid Earth, 120 (12), 8758-8773. doi: 10.1002/2015JB012419
[17] Yu, C., Penna, N. T., & Li, Z. (2017). Generation of real-time mode high-resolution water vapor fields from GPS observations. Journal of Geophysical Research: Atmospheres, 122 (3), 2008-2025. doi: 10.1002/2016JD025753
[18] Li, Z., Cao, Y., Wei, J., Duan, M., Wu, L., Hou, J., & Zhu, J. (2019). Time-series InSAR ground deformation monitoring: Atmospheric delay modeling and estimating. Earth-Science Reviews, 192, 258-284. doi: 10.1016/j.earscirev.2019.03.008
[19] Mao, W., Wang, X., Liu, G., Ma, P., Zhang, R., Ma, Z., Tang, J., & Lin, H. (2023). Ionospheric phase delay correction for time series multi-aperture InSAR constrained by polynomial deformation model. IEEE Geoscience and Remote Sensing Letters. 20, 1-5. doi: 10.1109/LGRS.2023.3281343
[20] Ferretti, A., Prati, C., & Rocca, F. (2000). Nonlinear subsidence rate estimation using permanent scatterers in differential SAR interferometry. IEEE Transactions on Geoscience and Remote Sensing, 38(5), 2202-2212. doi: 10.1109/36.868878
[21] Ma, P., Wang, W., Zhang, B., Wang, J., Shi, G., Huang, G., Chen, F., Jiang, L., & Lin, H. (2019). Remotely sensing large- and small-scale ground subsidence: A case study of the guangdong-hong kong-macao greater bay area of china. Remote Sensing of Environment, 232, 111282. doi: 10.1016/j.rse.2019.111282
[22] Ma, P., Zhang, F., & Lin, H. (2020). Prediction of InSAR time-series deformation using deep convolutional neural networks. Remote Sensing Letters, 11 (2), 137-145. doi: 10.1080/2150704X.2019.1692390
[23] Jiao, Z., Jia, G., & Cai, Y. (2019). A new approach to oil spill detection that combines deep learning with unmanned aerial vehicles. Computers & Industrial Engineering, 135, 1300-1311. doi: 10.1016/j.cie.2018.11.008
[24] Amodei, D., Ananthanarayanan, S., Anubhai, R., Bai, J., Battenberg, E., Case, C., Casper, J., Catanzaro, B., Cheng, Q., Chen, G., et al. (2016). Deep speech 2: End-to-end speech recognition in english and mandarin. International Conference on Machine Learning, 173-182.
[25] Vaswani, A., Shazeer, N., Parmar, N., Uszkoreit, J., Jones, L., Gomez, A. N., Kaiser, Ł., & Polosukhin, I. (2017). Attention is all you need. Advances in Neural Information Processing Systems, 30.
[26] Hochreiter, S., & Schmidhuber, J. (1997). Long short-term memory. Neural computation, 9(8), 1735-1780. doi: 10.1162/neco.1997.9.8.1735
[27] Cho, K., Van Merrienboer, B., Gulcehre, C., Bahdanau, D., Bougares, F., Schwenk, H., & Bengio, Y. (2014). Learning phrase representations using RNN encoder-decoder for statistical machine translation. arXiv Preprint arXiv: 1406.1078.
[28] Cai, Y., Guan, K., Peng, J., Wang, S., Seifert, C., Wardlow, B., & Li, Z. (2018). A high-performance and in-season classification system of field-level crop types using time-series landsat data and a machine learning approach. Remote Sensing of Environment, 210, 35-47. doi: 10.1016/j.rse.2018.02.045
[29] Ienco, D., Gaetano, R., Dupaquier, C., & Maurel, P. (2017). Land cover classification via multitemporal spatial data by deep recurrent neural networks. IEEE Geoscience and Remote Sensing Letters, 14(10), 1685-1689. doi: 10.1109/LGRS.2017.2728698
[30] Ma, P., Yu, C., Jiao, Z., Zheng, Y., Wu, Z., Mao, W., & Lin, H. (2024). Improving time-series InSAR deformation estimation for city clusters by deep learning-based atmospheric delay correction. Remote Sensing of Environment, 304, 114004. doi: 10.1016/j.rse.2024.114004
[31] Intrieri, E., Raspini, F., Fumagalli, A., Lu, P., Del Conte, S., Farina, P., Allievi, J., Ferretti, A., & Casagli, N. (2018). The maoxian landslide as seen from space: Detecting precursors of failure with sentinel-1 data. Landslides, 15, 123-133. doi: 10.1007/s10346-017-0915-7
[32] Zhao, Z., Wu, Z., Zheng, Y., & Ma, P. (2021). Recurrent neural networks for atmospheric noise removal from InSAR time series with missing values. ISPRS Journal of Photogrammetry and Remote Sensing, 180, 227-237. doi: 10.1016/j.isprsjprs.2021.08.009
[33] Shakeel, A., Walters, R. J., Ebmeier, S. K., & Al Moubayed, N. (2022). ALADDIn: Autoencoder-LSTM-based anomaly detector of deformation in InSAR. IEEE Transactions on Geoscience and Remote Sensing, 60, 1-12. doi: 10.1109/TGRS.2022.3169455
[34] Du, J., Yin, K., & Lacasse, S. (2013). Displacement prediction in colluvial landslides, three gorges reservoir, china. Landslides, 10, 203-218. doi: 10.1007/s10346-012-0326-8
[35] Zhou, C., Yin, K., Cao, Y., & Ahmed, B. (2016). Application of time series analysis and PSO-SVM model in predicting the bazimen landslide in the three gorges reservoir, china. Engineering Geology, 204, 108-120. doi: 10.1016/j.enggeo.2016.02.009
[36] Ma, P., Lin, H., Wang, W., Yu, H., Chen, F., Jiang, L., Zhou, L., Zhang, Z., Shi, G., & Wang, J. (2021). Toward fine surveillance: A review of multitemporal interferometric synthetic aperture radar for infrastructure health monitoring. IEEE Geoscience and Remote Sensing Magazine, 10(1), 207-230. doi: 10.1109/MGRS.2021.3098182
[37] Sandwell, D., Mellors, R., Tong, X., Wei, M., & Wessel, P. (2011). Open radar interferometry software for mapping surface deformation. Wiley Online Library. doi: 10.1029/2011EO280002
[38] Ferretti, A., Fumagalli, A., Novali, F., Prati, C., Rocca, F., & Rucci, A. (2011). A new algorithm for processing interferometric data-stacks: SqueeSAR. IEEE Transactions on Geoscience and Remote Sensing, 49(9), 3460-3470. doi: 10.1109/TGRS.2011.2124465
[39] Dragomiretskiy, K., & Zosso, D. (2013). Variational mode decomposition. IEEE Transactions on Signal Processing, 62(3), 531-544. doi: 10.1109/TSP.2013.2288675
[40] Huang, N. E., Shen, Z., Long, S. R., Wu, M. C., Shih, H. H., Zheng, Q., Yen, N.-C., Tung, C. C., & Liu, H. H. (1998). The empirical mode decomposition and the hilbert spectrum for nonlinear and non-stationary time series analysis. Proceedings of the Royal Society of London. Series A: Mathematical, Physical and Engineering Sciences, 454 (1971), 903-995. doi: 10.1098/rspa.1998.0193
[41] Paul, S. (2002). Addison, the illustrated wavelet transform handbook. In Inst. phys. (Vol. 1, pp. 117-154). doi: 10.1887/0750306920
[42] Kaur, C., Bisht, A., Singh, P., & Joshi, G. (2021). EEG signal denoising using hybrid approach of variational mode decomposition and wavelets for depression. Biomedical Signal Processing and Control, 65, 102337. doi: 10.1016/j.bspc.2020.102337
[43] Pang, B., Nazari, M., & Tang, G. (2022). Recursive variational mode extraction and its application in rolling bearing fault diagnosis. Mechanical Systems and Signal Processing, 165, 108321. doi: 10.1016/j.ymssp.2021.108321
[44] Li, C., & Liang, M. (2012). Time-frequency signal analysis for gearbox fault diagnosis using a generalized synchrosqueezing transform. Mechanical Systems and Signal Processing, 26, 205-217. doi: 10.1016/j.ymssp.2011.07.001
[45] Hilbert, D. (1953). Grundzuege einer allgemeinen theorie der linearen integralgleichungen, chelsea pub. Co., New York, 267.
[46] Bertsekas, D. P. (1976). Multiplier methods: A survey. Automatica, 12(2), 133-145. doi: 10.1016/0005-1098 (76) 90077-7
[47] Nocedal, J., & Wright, S. J. (1999). Numerical optimization. Springer.
[48] Bertsekas, D. (1982). Lagrange multiplier methods in constrained optimization. Academic Press.
[49] Hestenes, M. R. (1969). Multiplier and gradient methods. Journal of Optimization Theory and Applications, 4(5), 303-320. doi: 10.1007/BF00927673
[50] Rockafellar, R. T. (1973). A dual approach to solving nonlinear programming problems by unconstrained optimization. Mathematical Programming, 5 (1), 354-373. doi: 10.1007/BF01580138
[51] Nazari, M., & Sakhaei, S. M. (2017). Variational mode extraction: A new efficient method to derive respiratory signals from ECG. IEEE Journal of Biomedical and Health Informatics, 22 (4), 1059-1067. doi: 10.1109/JBHI.2017.2734074
[52] Che, Z., Purushotham, S., Cho, K., Sontag, D., & Liu, Y. (2018). Recurrent neural networks for multivariate time series with missing values. Scientific Reports, 8(1), 6085. doi: 10.1038/s41598-018-24271-9
[53] Bahdanau, D., Cho, K., & Bengio, Y. (2014). Neural machine translation by jointly learning to align and translate. arXiv Preprint arXiv: 1409.0473.
[54] Abadi, M., Agarwal, A., Barham, P., Brevdo, E., Chen, Z., Citro, C., Corrado, G. S., Davis, A., Dean, J., Devin, M., Ghemawat, S., Goodfellow, I., Harp, A., Irving, G., Isard, M., Jia, Y., Jozefowicz, R., Kaiser, L., Kudlur, M., . . . . Zheng, X. (2015). TensorFlow: Large-scale machine learning on heterogeneous systems. https://www.tensorflow.org/
[55] Kingma, D. P., & Ba, J. (2014). Adam: A method for stochastic optimization. arXiv Preprint arXiv: 1412.6980, G., Hammond, W., et al. (2018). Harnessing the GPS data explosion for interdisciplinary science. Eos, 99.
[56] Ding, J., Chen, J., Wang, J., & Zhang, Y. (2023). Characteristic differences in tropospheric delay between nevada geodetic laboratory products and NWM ray-tracing. GPS Solutions, 27(1), 47. doi: 10.1007/s10291-022-01385-2

We claim:

1. A surface deformation monitoring method based on time-series InSAR (TS-InSAR), comprising:
acquiring Synthetic Aperture Radar (SAR) data;
performing differential interferometry;
performing a robust two-tier multi-temporal InSAR method for detection of Persistent Scatterer (PS) and Distributed Scatterer (DS) candidates to acquire time series data for surface deformation monitoring;
performing a variational mode decomposition (VMD) method to decompose TS-InSAR data into a plurality of components;
reconstructing time series data;
performing a gated recurrent unit (GRU) method;
extracting trend of surface deformation; and
performing continuous large-scale deformation monitoring.

2. The method of claim 1, wherein the performing a robust two-tier multi-temporal InSAR method comprises determining whether condition 1 is satisfied; and if condition 1 is satisfied, more stable Persistent Scatterer (PS) candidates are identified to serve as reference; but if condition 1 is not satisfied, then performing a coherence-weighted phase-linking (CWPL) method for phase optimization.

3. The method of claim 2, further comprising constructing a first-tier network.

4. The method of claim 3, further comprising determining whether PSt1 is greater than a first preset value; and if PSt1 is greater than the first preset value, then performing the robust estimation method and performing the InSAR deformation of time-series; but if PSt1 is smaller than or equal to the first preset value, then constructing a second-tier network.

5. The method of claim 4, further comprising determining whether PSt2 is greater than a second preset value and DSt2 is greater than a third preset value; and if PSt2 is greater than the second preset value and DSt2 is greater than the third preset value, then performing a robust estimation method, and performing InSAR deformation of time-series.

6. The method of claim 2, wherein if condition 1 is not satisfied, further comprising identifying more PS candidates and DS candidates.

7. The method of claim 6, further comprising performing the constructing a second-tier network.

8. The method of claim 7, further comprising determining whether PSt2 is greater than a second preset value and DSt2 is greater than a third preset value; and if PSt2 is greater than the second preset value and DSt2 is greater than the third preset value, performing the robust estimation method and performing the InSAR deformation of time-series.

9. The method of claim 1, wherein the VMD method receives physics-based synthetic data as an input.

10. The method of claim 1, wherein the plurality of components include a trend component, a season component, and a noise component.

11. The method of claim 10, wherein the reconstructing time series comprises reconstructing time series data by removing the seasonal component.

12. The method of claim 1, wherein the GRU method receives synthetic data ground truth as an input.

13. The method of claim 1, wherein the performing a GRU method comprises refining reconstructed TS-InSAR data by the GRU method to eliminate noise and outliers.

14. A non-transitory computer readable medium having stored therein program instructions executable by a computing system to cause the computing system to perform a surface deformation monitoring method based on time-series InSAR (TS-InSAR), the method comprising:
acquiring Synthetic Aperture Radar (SAR) data;
performing differential interferometry;
performing a robust two-tier multi-temporal InSAR method for detection of Persistent Scatterer (PS) and Distributed Scatterer (DS) candidates to acquire time series data for surface deformation monitoring;
performing a variational mode decomposition (VMD) method to decompose TS-InSAR data into a plurality of components;
reconstructing time series data;
performing a gated recurrent unit (GRU) method;
extracting trend of surface deformation; and
performing continuous large-scale deformation monitoring.

15. The non-transitory computer readable medium of claim 14, wherein the performing a robust two-tier multi-temporal InSAR method comprises determining whether condition 1 is satisfied; and if condition 1 is satisfied, more stable Persistent Scatterer (PS) candidates are identified to serve as reference; but if condition 1 is not satisfied, performing a coherence-weighted phase-linking (CWPL) method for phase optimization.

16. The non-transitory computer readable medium of claim 15, further comprising constructing a first-tier network.

17. The non-transitory computer readable medium of claim 16, further comprising determining whether PSt1 is greater than a first preset value; and if PSt1 is greater than the first preset value, then performing the robust estimation method and performing the InSAR deformation of time-series; but if PSt1 is smaller than or equal to the first preset value, then constructing a second-tier network.

18. The non-transitory computer readable medium of claim 17, further comprising determining whether PSt2 is greater than a second preset value and DSt2 is greater than a third preset value; and PSt2 is greater than the second preset value and DSt2 is greater than the third preset value, then performing a robust estimation method, and performing InSAR deformation of time-series.

19. The non-transitory computer readable medium of claim 15, wherein if condition 1 is not satisfied, further comprising identifying more PS candidates and DS candidates.

20. The non-transitory computer readable medium of claim 19, further comprising performing the constructing a second-tier network.

21. The non-transitory computer readable medium of claim 20, further comprising determining whether PSt2 is greater than a second preset value and DSt2 is greater than a third preset value; and if PSt2 is greater than the second preset value and DSt2 is greater than the third preset value, performing the robust estimation method and performing the InSAR deformation of time-series.

22. The non-transitory computer readable medium of claim 14, wherein the VMD method receives physics-based synthetic data as an input.

23. The non-transitory computer readable medium of claim 14, wherein the plurality of components include a trend component, a season component, and a noise component.

24. The non-transitory computer readable medium of claim 23, wherein the reconstructing time series comprises reconstructing time series data by removing the seasonal component.

25. The non-transitory computer readable medium of claim 14, wherein the GRU method receives synthetic data ground truth as an input.

26. The non-transitory computer readable medium of claim 14, wherein the performing a GRU method comprises refining reconstructed TS-InSAR data by the GRU method to eliminate noise and outliers.
